(19) United States
(12) Patent Application Publication
(10) Pub. No.: US 2009/0000595 A1
(43) Pub. Date: Jan. 1, 2009

(54) Control Apparatus And Control Method Of An Internal Combustion Engine

(75) Inventors: Takeshi Ashizawa, Yokohama-shi (JP); Osamu Tomino, Susono-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/087,661

(22) PCT Filed: Mar. 9, 2007
(86) PCT No.: PCT/IB2007/000616

§ 371 Date: Jul. 11, 2008

(30) Foreign Application Priority Data
Mar. 10, 2006 (JP) 2006-065658

(51) Int. Cl. F02D 41/30

(52) U.S. Cl. 123/435

(57) ABSTRACT

A control apparatus of an in-cylinder injection type spark ignition internal combustion engine provided with at least an in-cylinder fuel injection valve that injects fuel directly into a cylinder executes temperature increase promotion control that promotes an increase in temperature near a nozzle hole of the in-cylinder fuel injection valve when a detected temperature near the nozzle hole of the in-cylinder fuel injection valve is within a deposit forming temperature range.

### BACKGROUND OF THE INVENTION

1. Field of the Invention

The invention relates to a control apparatus and control method of an internal combustion engine.

2. Description of the Related Art

Deposits sometimes accumulate near the nozzle holes of in-cylinder fuel injection valves located in the cylinders of in-cylinder injection type spark ignition internal combustion engines when the temperature around the nozzle holes is within a range within which deposits form (i.e., a deposit forming temperature range). When deposits accumulate around the nozzle holes in this way, they adversely affect the fuel injection quantity and the direction of the fuel injection and the like.

Therefore, it is necessary to inhibit deposits from accumulating near the nozzle holes of the in-cylinder fuel injection valves. Japanese Patent Application Publication No. JP-A-2002-364409, for example, describes technology for use in an in-cylinder injection type spark ignition internal combustion engine which is also provided another fuel injection valve in addition to the in-cylinder fuel injection valve, the other fuel injection valve being a port fuel injection valve that injects fuel into an intake port. This technology aims to lower the temperature near the nozzle hole to below the deposit forming temperature range by injecting a portion of the required fuel quantity from an in-cylinder fuel injection valve to cool the area near the nozzle hole even when the engine would operate more efficiently if fuel were injected from the port fuel injection valve.

At startup of the engine, the temperature near the nozzle hole of the in-cylinder fuel injection valve is below the deposit forming temperature range and rises to within the deposit forming temperature range as the engine warms up. However, when the in-cylinder fuel injection valve is arranged near a spark plug, the area near the nozzle hole heats up easily. As a result, once the engine has warmed up, even if the area near the nozzle hole is cooled by the maximum quantity of fuel being injected from the in-cylinder fuel injection valve, the temperature near the nozzle hole will still exceed the deposit forming temperature range beyond which new deposits will not form near the nozzle hole.

Accordingly, in the related art described above, even if it is possible to postpone the temperature near the nozzle hole of the in-cylinder fuel injection valve entering the deposit forming temperature range, the temperature near the nozzle hole will eventually enter that range. Thereafter, the temperature near the nozzle hole will have difficulty rising above the deposit forming temperature range due to that area being cooled by the injected fuel. As a result, a large amount of deposits may accumulate near the nozzle hole.

### SUMMARY OF THE INVENTION

This invention thus provides a control apparatus and control method of an internal combustion engine, which can inhibit the accumulation of deposits near a nozzle hole of an in-cylinder fuel injection valve in an in-cylinder injection type spark ignition internal combustion engine provided with an in-cylinder fuel injection valve that injects fuel directly into a cylinder.

A first aspect of the invention relates to a control apparatus of an internal combustion engine that is provided with at least an in-cylinder fuel injection valve which injects fuel directly into a cylinder, and executes a temperature increase promotion control that promotes an increase in temperature near a nozzle hole of the in-cylinder fuel injection valve when a detected temperature (which is detected by either being measured or estimated) near the nozzle hole of the in-cylinder fuel injection valve is within a deposit forming temperature range.

According to the first aspect, the temperature near the nozzle hole quickly rises above the deposit forming temperature range so the period of time during which the temperature near the nozzle hole is within the deposit forming temperature range is shorter, which means that the period of time during which deposits accumulate near the nozzle hole is shorter. As a result, the accumulation of deposits can be suppressed.

Also, in the first aspect, the temperature increase promotion control may be executed after a period of time during which the detected (i.e., measured or estimated) temperature near the nozzle hole of the in-cylinder fuel injection valve is within the deposit forming temperature range has reached a set period of time.

Accordingly, depending on the operating state of the engine, the temperature near the nozzle hole may exceed the deposit forming temperature range within the set period of time. When the temperature near the nozzle hole quickly exceeds the deposit forming temperature range in this way, the accumulation of deposits is suppressed so the temperature increase promotion control is not executed unnecessarily.

Also, in the first aspect, the internal combustion engine may further include a port fuel injection valve that injects fuel into an intake port, and execute the temperature increase promotion control by stopping fuel injection from the in-cylinder fuel injection valve and performing fuel injection from the port fuel injection valve.

Accordingly, stopping fuel injection from the in-cylinder fuel injection valve and performing fuel injection from the port fuel injection valve prevents the area near the nozzle hole of the in-cylinder fuel injection valve from being cooled by the fuel injected by that fuel injection valve. Thus, the temperature increase promotion control enables the temperature near the nozzle hole to quickly rise above the deposit forming temperature range.

Further, in the first aspect, the temperature increase promotion control may be executed by increasing the combustion temperature by advancing the ignition timing.

Accordingly, the temperature near the nozzle hole of the in-cylinder fuel injection valve can be increased by increasing the combustion temperature, which is achieved by advancing the ignition timing. Such temperature increase promotion control enables the temperature near the nozzle hole to quickly exceed the deposit forming temperature range.

Also, in the first aspect, the in-cylinder fuel injection valve may selectively change an injection rate between at least two levels, one of which is a low injection rate and the other of which is a high injection rate. Fuel is injected with the injection rate of the in-cylinder fuel injection valve set to the high injection rate when increasing the combustion temperature according to the temperature increase promotion control.

Accordingly, fuel may be injected with the injection rate of the in-cylinder fuel injection valve set to the high injection rate. As a result, the temperature near the nozzle hole of the in-cylinder fuel injection valve rises by the high combustion temperature and thus quickly exceeds the deposit forming temperature range. Also, even if deposits do accumulate near the nozzle hole while the temperature near the nozzle hole is within the deposit forming temperature range, those deposits can easily be blown away by the fuel spray of the high injection rate that is injected from the in-cylinder fuel injection valve.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a bottom view schematically showing a cylinder head of an in-cylinder injection type spark ignition internal combustion engine provided with a control apparatus according to the invention;

FIG. 2 is a longitudinal sectional view schematically showing the in-cylinder injection type spark ignition internal combustion engine in FIG. 1; and

FIG. 3 is a flowchart of control to suppress the accumulation of deposits which is executed by the control apparatus according to the invention.

### DETAILED DESCRIPTION OF THE PREFERRED EMBODIMENTS

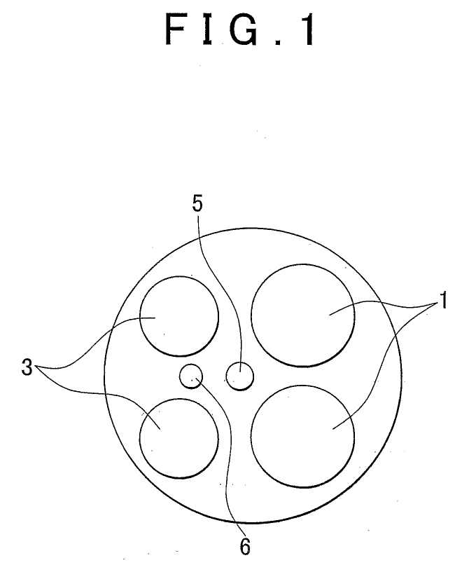

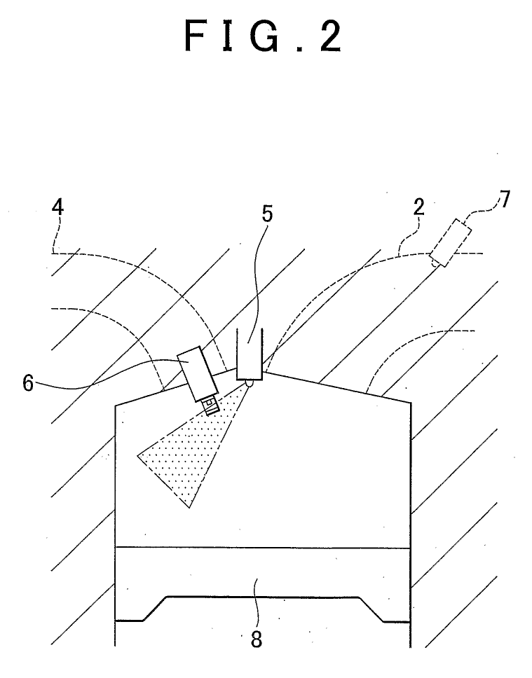

FIG. 1 is a bottom view schematically showing a cylinder head of an in-cylinder injection type spark ignition internal combustion engine provided with a control apparatus according to the invention, and FIG. 2 is a longitudinal sectional view schematically showing the in-cylinder injection type spark ignition internal combustion engine in FIG. 1. As shown in these drawings, the in-cylinder injection type spark ignition internal combustion engine (hereinafter simply referred to as “internal combustion engine”) includes a pair of intake valves 1, an intake port 2 which opens into a cylinder via the intake valves 1, a pair of exhaust valves 3, an exhaust port 4 which opens into the cylinder via the exhaust valves 3, an in-cylinder fuel injection valve 5 arranged substantially in the center in the upper portion of the cylinder, a spark plug 6 arranged near the in-cylinder fuel injection valve 5, a port fuel injection valve 7 arranged in the intake port 2, and a piston 8.

When the engine load is smaller than a set load, the in-cylinder fuel injection valve 5 of the internal combustion engine injects fuel which passes through the spark gap of the spark plug 6 during the latter half of the compression stroke, as shown in FIG. 2. The in-cylinder fuel injection valve 5 preferably injects the fuel in a spray that spreads out in a hollow or solid conical shape, or a relatively thin flat general fan shape. As a result, the fuel spray easily atomizes and vaporizes by the friction with the intake air as it flies around inside the cylinder, forming a cloud of a combustible air-fuel mixture in part of the cylinder at the ignition timing. The combustible air-fuel mixture formed in this way contacts the spark gap of the spark plug 6 and is reliably ignited such that good stratified-charge combustion can be achieved. During stratified-charge combustion, the overall air-fuel ratio in the cylinder is leaner than the stoichiometric air-fuel ratio so less fuel is consumed.

Also, when the engine load is a high load equal to or greater than the set load, the port fuel injection valve 7 of the internal combustion engine injects fuel in sync with the intake stroke or out of sync with intake strokes so fuel is supplied to the cylinder together with intake air during the intake stroke. As a result, the time until ignition is sufficiently long which enables the injected fuel to diffuse throughout the entire cylinder such that a homogeneous air-fuel mixture forms inside the cylinder at the ignition timing. The homogeneous air-fuel mixture formed in this way is reliably ignited such that good homogeneous combustion can be achieved. During homogeneous combustion, the overall air-fuel ratio in the cylinder may be leaner than the stoichiometric air-fuel ratio, although greater engine output can be obtained by having the air-fuel ratio be the stoichiometric air-fuel ratio or richer than the stoichiometric air-fuel ratio.

If the port fuel injection valve 7 is not provided, then fuel is injected by the in-cylinder fuel injection valve 5 at the end of the intake stroke for homogeneous combustion. In this case, it is preferable that a tumble flow or swirl flow form inside the cylinder during the intake stroke. This tumble flow or swirl flow disperses the injected fuel throughout the cylinder so that a homogeneous air-fuel mixture is formed at the ignition timing.

Also, fuel injected by the port fuel injection valve 7 and supplied together with intake air into the cylinder is advantageous for homogeneity in the cylinder during homogeneous combustion. On the other hand, fuel injected by the in-cylinder fuel injection valve 5 during the intake stroke is advantageous for increasing the intake air charging efficiency in order to lower the cylinder internal temperature by the latent heat of vaporization of the fuel. Therefore, during homogeneous combustion, fuel may be injected from both the port fuel injection valve 7 and the in-cylinder fuel injection valve 5. In this case, the required amount of fuel to be injected is injected at an injection rate of the in-cylinder fuel injection valve 5 and the port fuel injection valve 7. The injection rate of the in-cylinder fuel injection valve 5 is preferably set larger the greater the required engine output in order to increase the intake air charging efficiency.

Also, homogeneous combustion with fuel being injected using both the in-cylinder fuel injection valve 5 and the port fuel injection valve 7 in this way may also be performed in all operating states of the engine and stratified-charge combustion not performed at all.

In particular, as in this in-cylinder injection type spark ignition internal combustion engine, when both the in-cylinder fuel injection valve 5 and the spark plug 6 are arranged in the upper portion of the cylinder, the in-cylinder fuel injection valve 5 is often positioned near the spark plug 6 which reaches the highest temperature of any part in the cylinder, regardless of whether stratified-charge combustion or homogeneous combustion is performed. Therefore, the area near the nozzle hole of the in-cylinder fuel injection valve 5 heats up sufficiently such that after the engine is warmed up, the temperature near the nozzle hole will exceed approximately 200° C. even when cooled by a fuel injection during both stratified-charge combustion and homogeneous combustion. Therefore, even if fuel in a liquid state adheres near the nozzle hole, that fuel will boil and form beads, and thus tends not to become deposits of simmering fuel.

However, the temperature near the nozzle hole at startup of the engine is low, i.e., close to atmospheric temperature. Therefore, as the temperature near the nozzle hole gradually rises as the engine warms up, it will eventually enter the deposit forming temperature range which is between approximately 150° C. and approximately 180° C., inclusive. At this time there is a tendency for deposits to form near the nozzle hole.

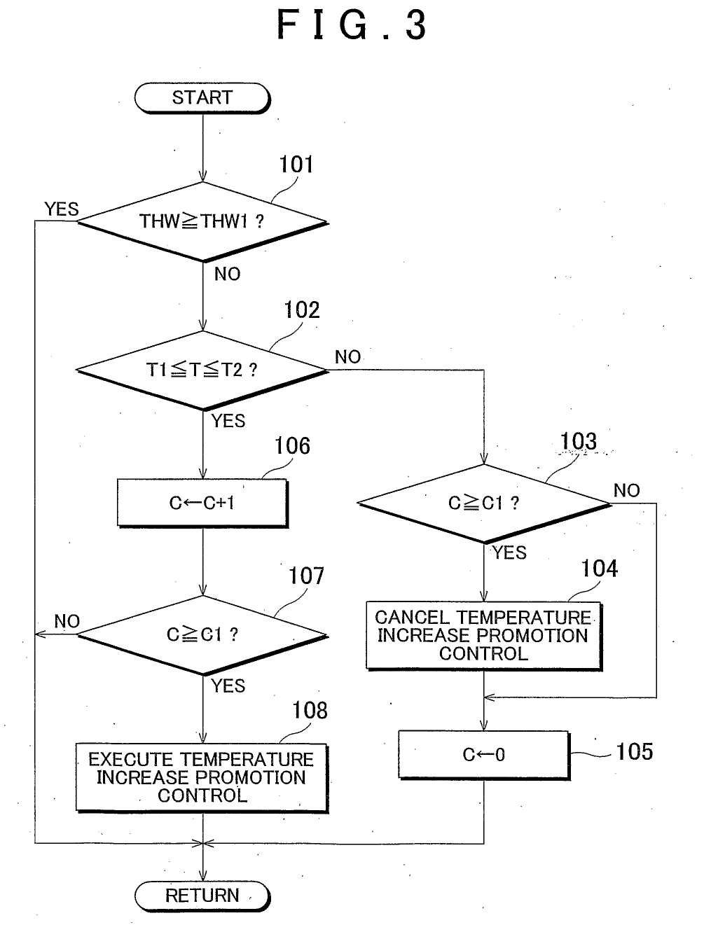

The control apparatus according to an embodiment of this invention suppresses deposits from accumulating near the nozzle hole of the in-cylinder fuel injection valve 5 according to the control illustrated in the flowchart in FIG. 3. First in step 101, it is determined whether a coolant temperature THW indicative of the engine temperature is equal to or greater than a set coolant temperature THW1. If the determination is YES, then the engine has finished warming up and the temperature T near the nozzle hole of the in-cylinder fuel injection valve 5 is above approximately 200° C., i.e., beyond the deposit forming temperature range, so new deposits will not accumulate near the nozzle hole. Therefore this cycle of the routine ends.

If, on the other hand, the determination in step 101 is NO, the engine has not yet finished warming up so in step 102 it is determined whether the temperature T near the nozzle hole of the in-cylinder fuel injection valve 5 is within the deposit forming temperature range (i.e., between T1 and T2, inclusive). The temperature T near the nozzle hole may be measured by a temperature sensor arranged near the nozzle hole or may be estimated based on the cylinder internal temperature which is measured by a temperature sensor arranged within the cylinder. Also, the combustion temperature may be estimated based on the fuel injection quantity and the temperature T near the nozzle hole estimated from this estimated combustion temperature.

If the determination in step 102 is NO, i.e., if it is determined that the temperature T near the nozzle hole is lower than T1 or higher than T2, deposits will not easily form so in step 103 it is determined whether a count value C is equal to or greater than a set value C1. If the determination in step 103 is YES, temperature increase promotion control, which will be described in detail later, is being executed so in step 104 this control is cancelled. Also, if the determination in step 103 is NO, the process proceeds directly to step 105 where the count value C is reset to zero, after which this cycle of the routine ends.

If, on the other hand, the determination in step 102 is YES, the temperature T near the nozzle hole of the in-cylinder fuel injection valve 5 has risen to within the deposit forming temperature range as the engine warms up. At this time, the count value C that was reset to zero in step 105 is increased by one in step 106. Next in step 107, it is determined whether the count value C has reached the set value C1. If this determination is NO, this cycle of the routine ends.

When the increase in the count value C in step 106 is repeated, the determination in step 107 will eventually be YES, at which time temperature increase promotion control which promotes an increase in the temperature T near the nozzle hole of the in-cylinder fuel injection valve 5 is executed in step 108. That is, the temperature increase promotion control is executed when the period of time during which the temperature T near the nozzle hole is within the deposit forming temperature range reaches the set period of time that it takes for the initial count value C of 0 to be increased to the set value C1.

In other words, depending on the operating state of the engine while the engine is warming up, the area near the nozzle hole may warm up sufficiently such that the temperature T near the nozzle hole rises above the deposit forming temperature range before the period of time during which the temperature T near the nozzle hole is within the deposit forming temperature range reaches the set period of time. In this case, the temperature increase promotion control is not executed.

The temperature increase promotion control stops the injection of fuel from the in-cylinder fuel injection valve 5 so that the area near the nozzle hole of the in-cylinder fuel injection valve 5 is not cooled by the injected fuel. In this case, the engine must operate with fuel being injected from the port fuel injection valve 7. The temperature increase promotion control quickly raises the temperature T near the nozzle hole above the deposit forming temperature range, thereby reducing the amount of deposits that accumulate near the nozzle hole in the deposit forming temperature range.

For example, if stratified-charge combustion is being performed with fuel injected from the in-cylinder fuel injection valve 5 when this temperature increase promotion control is executed, the execution of the temperature increase promotion control cancels the stratified-charge combustion and homogeneous combustion is instead performed with fuel injected from the port fuel injection valve 7. Also, if homogeneous combustion is being performed with fuel injected from the in-cylinder fuel injection valve 5 and the port fuel injection valve 7 when that temperature increase promotion control is executed, homogeneous combustion continues to be performed but with the injection rate of the port fuel injection valve 7 at 100%.

Also, temperature increase promotion control may instead increase the combustion temperature by advancing the ignition timing. The temperature increase promotion control also quickly raises the temperature T near the nozzle hole above the deposit forming temperature range, thereby reducing the amount of deposits that accumulate near the nozzle hole in the deposit forming temperature range.

If stratified-charge combustion is being performed when this temperature increase promotion control is executed, it is preferable to switch to homogeneous combustion. During homogeneous combustion which advances the ignition timing, fuel may be injected using only the in-cylinder fuel injection valve 5. Accordingly, the temperature increase promotion control can also be applied to an in-cylinder injection type spark ignition internal combustion engine which does not have a port fuel injection valve 7.

Further, when using temperature increase promotion control that increases the combustion temperature by advancing the ignition timing and fuel is injected using the port fuel injection valve 7, the area near the nozzle hole of the in-cylinder fuel injection valve 5 is cooled less by the fuel injected from that in-cylinder fuel injection valve 5 by making the injection rate of the in-cylinder fuel injection valve 5 either 0% or small so that the temperature T near the nozzle hole will quickly rise above the deposit forming temperature range.

Also, if the injection rate of the in-cylinder fuel injection valve 5 is switched between at least a low injection rate and a high injection rate by, for example, changing the lift amount of the valve body, then the fuel injection from the in-cylinder fuel injection valve 5 is preferably set to the high injection rate when the temperature increase promotion control increases the combustion temperature by advancing the ignition timing. Accordingly, even if deposits form when the temperature T near the nozzle hole is within the deposit forming temperature range, the deposits that accumulate near the nozzle hole can be blown off by fuel spray injected at the high injection rate from the in-cylinder fuel injection valve 5.

As described above, the temperature increase promotion control switches the combustion from stratified-charge combustion to homogeneous combustion or advances the ignition timing, both of which adversely affect fuel consumption. Therefore, as shown in the flowchart in FIG. 3, if the temperature T near the nozzle hole of the in-cylinder fuel injection valve 5 exceeds the deposit forming temperature range before the period of time during which the temperature T near the nozzle hole of the in-cylinder fuel injection valve 5 is within the deposit forming temperature range reaches the set period of time, i.e., if the temperature T near the nozzle hole quickly rises above the deposit forming temperature range, the temperature increase promotion control which has an adverse affect on fuel consumption is not performed. However, temperature increase promotion control may immediately be executed as soon as the temperature T near the nozzle hole enters the deposit forming temperature range so that the temperature T near the nozzle hole rises above the deposit forming temperature range even faster.

According to the control apparatus of this example embodiment, the temperature T near the nozzle hole of the in-cylinder fuel injection valve 5 is increased so that it quickly exceeds the deposit forming temperature range. Even so, slight deposits may still accumulate near the nozzle hole when the temperature T near the nozzle hole is within the deposit forming temperature range. Therefore, when the temperature T near the nozzle hole has exceeded the deposit forming temperature range, homogeneous combustion which makes the combustion air-fuel ratio leaner than the stoichiometric air-fuel ratio is preferably performed by advancing the ignition timing. The fuel injection at this time can be performed by one or both of the in-cylinder fuel injection valve 5 and the port fuel injection valve 7. In particular, injecting the entire required amount of fuel at the high injection rate by the in-cylinder fuel injection valve 5 will blow away deposits that accumulate near the nozzle hole. Also, if homogeneous combustion with a lean air-fuel ratio is performed by increasing the combustion temperature which is achieved by advancing the ignition timing, then a sufficient amount of oxygen will remain in the cylinder and the temperature in the cylinder will rise so slight deposits that accumulate near the nozzle hole of the in-cylinder fuel injection valve 5 can easily be burned off or peeled off from near the nozzle hole.

Homogeneous combustion with a lean air-fuel ratio that advances the ignition timing does not have to be performed when the temperature T near the nozzle hole of the in-cylinder fuel injection valve 5 exceeds the deposit forming temperature range every time that the engine is started. Alternatively, that homogeneous combustion may be performed when the temperature T near the nozzle hole exceeds the deposit forming temperature range every n^{th} time that the engine is started.

1. A control apparatus of an internal combustion engine, comprising:
an in-cylinder fuel injection valve that injects fuel directly into a cylinder;
a temperature detector which detects a temperature near a nozzle hole of the in-cylinder fuel injection valve; and
a controller which executes temperature increase promotion control that promotes an increase in temperature near the nozzle hole when the temperature detected by the temperature detector is within a deposit forming temperature range within which deposits tend to form near the nozzle hole of the in-cylinder fuel injection valve.

2. The control apparatus according to claim 1, wherein the controller executes the temperature increase promotion control after a period of time during which the detected temperature near the nozzle hole of the in-cylinder fuel injection valve is within the deposit forming temperature range has reached a set period of time.

3. The control apparatus according to claim 1, wherein the internal combustion engine further includes a port fuel injection valve that injects fuel into an intake port, and the controller executes the temperature increase promotion control by reducing a ratio of a fuel injection quantity from the in-cylinder fuel injection valve to the fuel injection quantity from the port fuel injection valve.

4. The control apparatus according to claim 3, wherein the controller executes the temperature increase promotion control by stopping fuel injection from the in-cylinder fuel injection valve and performing fuel injection from the port fuel injection valve.

5. The control apparatus according to claim 1, wherein the controller executes the temperature increase promotion control by advancing an ignition timing.

6. The control apparatus according to claim 5, wherein the in-cylinder fuel injection valve selectively changes an injection rate between at least two levels, one of which is a low injection rate and the other of which is a high injection rate, and the controller selects the injection rate of the in-cylinder fuel injection valve to be the high injection rate when increasing a combustion temperature by the temperature increase promotion control.

7. The control apparatus according to claim 1, wherein the deposit forming temperature range is a range between approximately 150° C. and 180° C., inclusive.

8. A control method of an internal combustion engine which has an in-cylinder fuel injection valve that injects fuel directly into a cylinder, comprising the steps of:
detecting a temperature near a nozzle hole of the in-cylinder fuel injection valve; and
promoting an increase in temperature near the nozzle hole when the detected temperature is within a deposit forming temperature range within which deposits tend to form near the nozzle hole of the in-cylinder fuel injection valve.

9. The control method according to claim 8, further comprising the steps of:
measuring a period of time during which the detected temperature near the nozzle hole of the in-cylinder fuel injection valve is within the deposit forming temperature range, and
promoting an increase in temperature near the nozzle hole after the measured period of time reaches a set period of time.

10. The control method according to claim 8, wherein the step of promoting an increase in temperature includes a step of stopping fuel injection from the in-cylinder fuel injection valve and performing fuel injection from a port fuel injection valve.
